(19) United States
(12) Patent Application Publication
(10) Pub. No.: US 2018/0173823 A1
(43) Pub. Date: Jun. 21, 2018

(54) SIMULATION DEVICE, SIMULATION METHOD, AND RECORDING MEDIUM FOR STORING PROGRAM

(71) Applicant: NEC Corporation, Minato-ku, Tokyo (JP)

(72) Inventors: Mineto SATOH, Tokyo (JP); Soichiro ARAKI, Tokyo (JP)

(73) Assignee: NEC Corporation, Minato-ku, Tokyo (JP)

(21) Appl. No.: 15/577,381

(22) PCT Filed: Jun. 2, 2016
(86) PCT No.: PCT/JP2016/002675

§ 371 Date: Nov. 28, 2017

(30) Foreign Application Priority Data
Jun. 2, 2015 (JP) 2015-111855

(51) Int. Cl. G06F 17/50; G06F 17/16

(52) U.S. Cl. CPC G06F 17/5009; G06F 2217/16; G06F 17/16

(57) ABSTRACT

A simulation device and the like are provided such that predicting capability and calculation resource efficiency can be both improved. The simulation device pertaining to an embodiment of the present invention is provided with: a model ensemble means for calculating, on the basis of a state vector as an input, time evolutions of the state vector through simulation using at least two different models in accordance with the models; a posterior distribution generation means for generating posterior distributions of the time evolutions of the state vector and model likelihoods, that is, likelihoods derived from observation data of the models, on the basis of the time evolutions of the state vector and the observation data; and a posterior distribution weighting determination means for determining weights to be applied to the posterior distributions on the basis of the posterior distributions and the model likelihoods, and calculating the next state vector on the basis of the weights and the posterior distributions.

### TECHNICAL FIELD

The present invention relates to a simulation technique for mathematically modelling and calculating numerically on a computer a phenomenon occurring at a real world or a hypothetical situation.

### BACKGROUND ART

A simulation corresponds to a technique for mathematically modeling and calculating numerically on a computer a phenomenon occurring in a real world or a hypothetical situation. By mathematically modelling, the calculation can be made by freely setting the time or the space. By the simulation, it is possible to predict a situation an actual result of which is difficult to obtain (for example, a situation of a place where the observation is difficult) or a phenomenon which may occur in future. By intentionally changing the calculation condition, the feature or the behavior in the situation which is difficult to be found in reality can be investigated. The results of such simulation can serve as indexes of the theoretical investigation of the causal relationship, design, and a plan.

Especially, in the prediction based on the mathematical model, there are problems to improve not only a prediction result after calibration (i.e. correction) by the actual observed value, but also prediction capability (hereinafter, referred to as generalization ability) for unobserved and unknown objects. The generalization ability is improved by reducing a generalization error of output of a model. The generalization error here is represented by the variance (i.e. variation) and the bias (i.e. deviation). In handling the unknown object, it is important that a model is capable of accurately simulating a behavior of an object according to inputs including conditions such as an initial condition and a boundary condition, and variable parameters, which represent a feature of the model. In other words, a degree of freedom settable from an outside is left in a model. An object is to reduce variance and bias under the degree of freedom settable from the outside. However, in many cases, the model that handles a predetermined territory (i.e. a domain) based especially on a physical law and a theory is modelized and improved for each investigative group, businesses, institutes, fields, objects, and regions, and thus, the satisfactory accuracy may not be expected to objects other than the immediate investigation object. Typically, when the model is too adapted to the specified object, i.e., when the degree of freedom is small, the bias tends to be large while the variance is small. On the other hand, when the general versatility of the model is high, i.e., the degree of freedom is large, the variance is large while the bias is small. Therefore, in order to reduce the generalization error, it is necessary to solve the trade-off between the variance and the bias depending on the feature of the model.

As a mechanism for reducing such a generalization error, concepts using the ensemble (i.e. aggregation) is proposed. One of the concepts is a data assimilation in which variables of the model are handled as the ensemble. The data assimilation is known as a method of integrating the observation data obtained in reality into a numerical simulation, and especially has been developed in the fields of earth science, oceanographic science, and aerography. By handling the variables calculated through the simulation as the ensemble, the data assimilation finds, from the ensemble, the simulation result that is most adapted to the observation data obtained in reality. At the same time, the data assimilation also updates the model and the simulation condition. Accordingly, use of the data assimilation causes the degree of freedom of the model to be increased by the variable ensemble, and thus, the bias is reduced.

For example, NPL1 discloses a method of model ensemble in which a combination of a plurality of models is treated as the ensemble. In this method, at least two or more models each including outputs corresponding to the physical quantities of the same kind are prepared, a simulation is performed for the identical object, and their respective output results are averaged. As described above, models are developed independently for each object and territory in many cases, in order to reduce the generalization error, and thus needs to be adapted to various objects and territories. Therefore, even if a simulation is performed for the identical object, a plurality of models having different output results, i.e., a plurality of models having strengths and weaknesses depending on objects and territories are prepared. Averaging in a combinations of a plurality of output results is capable of increasing the number of output results included in the combinations, i.e., the number of ensemble, and thereby variance can be reduced

### CITATION LIST

### Non Patent Literature

[NPL 1] Tao Li, Toshihiro Hasegawa, et al, “Uncertainties in predicting rice yield by current crop models under a wide range of climatic conditions”, Global Change Biology (2014), DOI: 10.1111/gcb.12758

### SUMMARY OF INVENTION

### Technical Problem

In the above described technique of the data assimilation and the technique disclosed in NPL1, the ensemble (i.e. an aggregation) is used in order to improve predicting capability (i.e. generalization ability) for an unobserved and unknown object. However, variance and bias exist as items of generalization errors that influences the predicting capability, and the variance and the bias have a trade-off relationship depending on a degree of freedom which is a characteristic of a model. A problem is that the trade-off relationship is not able to be overcome by merely using the ensemble. For example, in the above described method using the data assimilation, although the bias in the error is reduced, the existence of a modeling error that is intrinsic in the model and the observation error included in the observation data corresponds to increase in the degree of freedom of the model, and thus, a rate of reduction in the variance is limited. In the above described method using the ensemble of models, although the variance of the error is reduced, which corresponds to, concerning individual models, a case in which a model is adapted to a specific object, i.e., a case in which the degree of freedom is small, and thus, the bias is not reduced. As above, with the currently proposed techniques, the trade-off solution of the variance and the bias does not come to be made.

In the method using the ensemble to reduce an error, since calculation is needed individually for the elements (i.e. ensemble members) in the ensemble, the problem is that required computing resources increase proportionally to an ensemble number. Therefore, the predictive accuracy and the computing resource are in the trade-off relationship.

One of objects of the present invention is to provide a simulation device and the like which can improve both a predicting capability and a calculation resource efficiency.

### Solution to Problem

A simulation device according to an exemplary aspect of the present invention includes: model ensemble means for calculating, based on a state vector as an input, time evolutions of the state vector by simulation according to models, for at least two different models; posterior distribution generation means for generating, based on the time evolutions of the state vector and observation data, posterior distributions of the time evolutions of the state vector and model likelihoods that are likelihoods, based on the observation data, of the models; and posterior distribution weight determination means for determining, based on the posterior distributions and the model likelihoods, weights of the posterior distributions, and calculating, based on the weights and the posterior distributions, a next state vector of the state vector.

A simulation method according to an exemplary aspect of the present invention includes: calculating, based on a state vector as an input, time evolutions of the state vector by simulation according to models, for at least two different models; generating, based on the time evolutions of the state vector and observation data, posterior distributions of the time evolutions of the state vector and model likelihoods that are likelihoods, based on the observation data, of the models; and determining, based on the posterior distribution and the model likelihood, weights of the posterior distributions, and calculating, based on the weights and the posterior distributions, a next state vector of the state vector.

A storage medium according to an exemplary aspect of the present invention stores a program that causes a computer to operate as: model ensemble means for calculating, based on a state vector as an input, time evolutions of the state vector by simulation according to models, for at least two different models; posterior distribution generation means for generating, based on the time evolutions of the state vector and observation data, posterior distributions of the time evolutions of the state vector and model likelihoods that are likelihoods, based on the observation data, of the models; and posterior distribution weight determination means for determining, based on the posterior distributions and the model likelihoods, weights of the posterior distributions, and calculating, based on the weights and the posterior distributions, a next state vector of the state vector. An exemplary aspect of the present invention can be also achieved by the above-described program.

### Advantageous Effects of Invention

The present invention has an effect that both the predicting capability and the calculation resource efficiency can be improved.

### BRIEF DESCRIPTION OF DRAWINGS

FIG. 1 is a block diagram schematically illustrating a configuration of a simulation device 100 according to a first example embodiment of the present invention.

FIG. 2 is a drawing schematically illustrating operation examples of a posterior distribution weight determination unit 33 in the simulation device 100 according to the first example embodiment of the present invention.

FIG. 3 is a flowchart illustrating operations of the simulation device 100 according to the first example embodiment of the present invention.

FIG. 4 is a block diagram schematically illustrating a configuration of a simulation device 200 according to a second example embodiment of the present invention.

FIG. 5 is a block diagram illustrating a configuration example of a simulation device 300 of a third example embodiment of the present invention.

FIG. 6 is a drawing illustrating one example of a hardware configuration of a computer 1000 that can implement the simulation devices 100, 200 and 300.

### DESCRIPTION OF EMBODIMENTS

Hereinafter, example embodiments of the present invention are described with reference to the drawings. In each drawing, an identical element is denoted with an identical reference sign, and duplicated descriptions are omitted as needed.

### First Example Embodiment

The simulation device 100 according to the first example embodiment of the present invention is described. The simulation device 100 is applicable to a simulation following a time evolution by solving a partial differential equation of the continuous time and space on the basis of a physical law. As such a partial differential equation, there are, for example, an equation of motion describing motion, a Navier□Stokes equation describing fluid, a thermodynamic equation describing heat change, and the shallow□water wave equation describing tsunami. The simulation device 100 is also applicable to a simulation using the finite element method. In the present example embodiment, a system that is a target of simulation is assumed to be a system in which the state vector following a change over time is connected with actual observation data via some sort of relational equation, i.e., a system in which a simulation result and observation data can be compared.

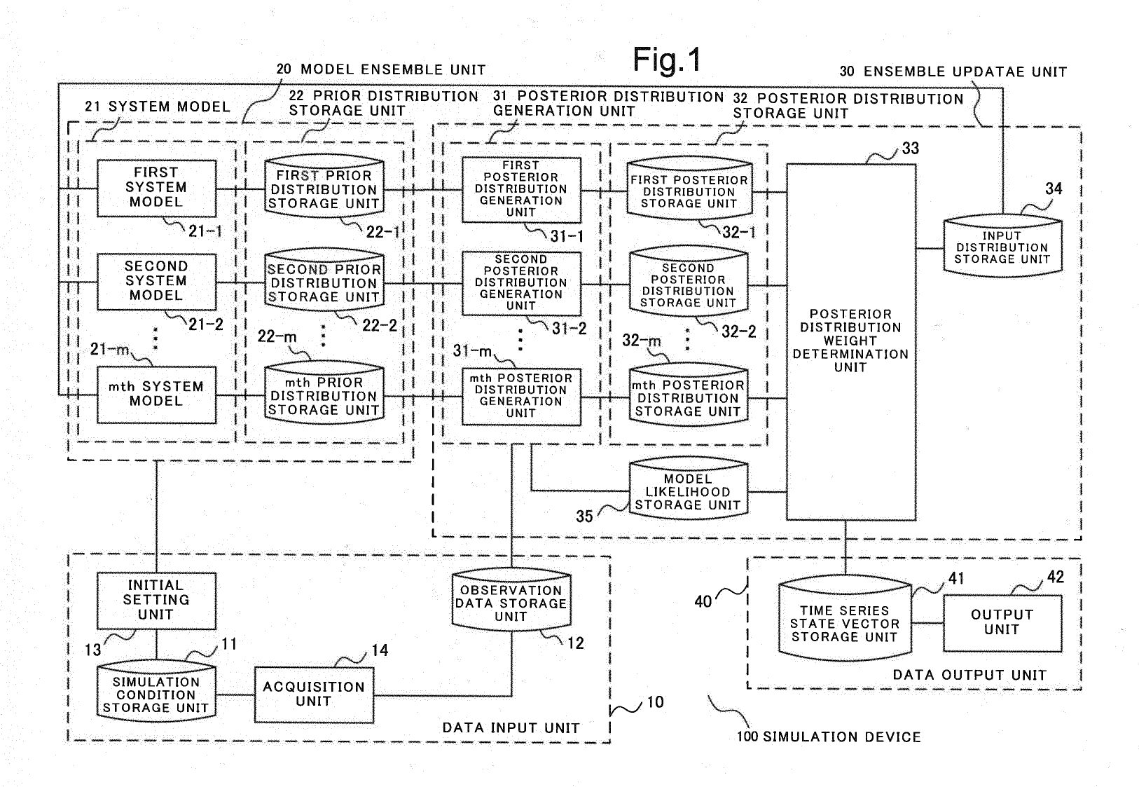

First, FIG. 1 illustrates a configuration of the simulation device 100. In FIG. 1, the simulation device 100 includes a data input unit 10, a model ensemble unit 20, an ensemble update unit 30, and a data output unit 40. The data input unit 10 includes an initial setting unit 13 and an acquisition unit 14. The model ensemble unit 20 includes m system models 21 (i.e., a first system model 21-1 to an mth system model 21-m). The ensemble update unit 30 includes m posterior distribution generation units 31 (i.e., a first posterior distribution generation unit 31-1 to an mth posterior distribution generation unit 31-m) and the posterior distribution weight determination unit 33. The data output unit 40 includes an output unit 42. Note that, m is an integer of two or more. In FIG. 1, the simulation device 100 includes, for example, storage units specifically described below as storage area of data which is input and output between functional blocks. Specifically, the data input unit 10 in the simulation device 100 includes a simulation condition storage unit 11 storing a simulation condition and an observation data storage unit 12 storing observation data. The model ensemble unit 20 in the simulation device 100 includes m prior distribution storage units 22 storing prior distribution (i.e., a first prior distribution storage unit 22-1 to an mth prior distribution storage unit 22-m). The ensemble update unit 30 in the simulation device 100 includes m posterior distribution storage units 32 storing posterior distribution (i.e., a first posterior distribution storage unit 32-1 to an mth posterior distribution storage unit 32-m). An ensemble update unit 30 in the simulation device 100 includes an input distribution storage unit 34 storing input distribution and a model likelihood storage unit 35 storing model likelihood. The input distribution storage unit 34 may be implemented by m storage units (also referred to as m input distribution storage unit 34 (i.e., a first input distribution storage unit 34-1 to an mth input distribution storage unit 34-m)). The data output unit 40 in the simulation device 100 includes a time series state vector storage unit 41 storing time series of a state vector which is a result of the simulation.

Next, details of each functional block of the simulation device 100 are described.

First, the data input unit 10 is described. The acquisition unit 14 of the data input unit 10 acquires a simulation condition including an initial state of a state vector used for simulation and parameters, and observation data. The acquisition unit 14 may acquire the simulation condition and the observation data from, for example, a control device (not illustrated), a server device (not illustrated) or the like. The acquisition unit 14 stores the acquired simulation condition in the simulation condition storage unit 11 which is a storage area of the simulation condition. The data input unit 10 further stores the acquired observation data in the observation data storage unit 12 which is a storage area of the observation data. The observation data is an observed value by a sensor or the like. The parameters included in the simulation condition are a time step, a specified time until an end, a state variable for which time evolutions are derived, and the like which are necessary conditions for performing the object simulation. The initial setting unit 13 generates an ensemble of an initial state and parameters on the basis of information stored in the simulation condition storage unit 11. The initial setting unit 13 inputs the ensemble of the initial state and the parameter to each of the m system models 21.

Next, the model ensemble unit 20 is described. The model ensemble unit 20 includes the m system models 21 (i.e., the first system model 21-1 to an mth system model 21-m). In each example embodiment of the present invention, each of the m system models 21 is, for example, dedicated hardware such as a circuit that transforms a state vector, which is input, to a state vector at time of a next step according to a model represented by mapping as described later. Each of the m system models 21 may be implemented by a computer and a program that controls the computer. Each of the m system models 21 may be implemented by a combination of a computer with a program that controls the computer, and dedicated hardware. The model ensemble unit 20 further includes the m prior distribution storage units 22 (i.e. the first prior distribution storage unit 22-1 to the mth prior distribution storage unit 22-m) that are data storage areas each associated with the m system models 21. In the simulation device 100, a set of state variables tracing time evolutions of a phenomenon in reality is represented by a state vector X. The state vector at the time t+1 which is one step proceeding from the state vector Xₜ at the time t is referred to as Xₜ₊₁. For example, assume that the state vector Xₜ₋₁ at the time t−1 is updated by the first system model 21-1 and a second system model 21-2 into the state vector X_{1,t} and the state vector X_{2,t} at the time t. When mappings representing updates by the first system model 21-1 and the second system model 21-2 are referred to as f1 and f2, respectively, updates of the state vector Xₜ₋₁ by the first system model 21-1 and the second system model 21-2 are described by the relational expression represented in the expression (1).

[Math. 1]

X_{1,t}=f₁(Xₜ₋₁,θ₁,v₁ₜ)

X_{2,t}=f₂(Xₜ₋₁,θ₂,v₂ₜ) (1)

The expression (1) represents that, even if the state at the time t−1 is an identical state Xₜ₋₁, the identical state Xₜ₋₁ at the time t transfers to states X_{1,t} and X_{2,t} which are different from each other by using a plurality of system models. The θ₁ and θ₂ represent parameter vectors required for calculation of their respective models, and v₁ₜ and v₂ₜ represent system noise introduced as stochastic driving terms that influence the state vectors in order to numerically represent the effects of imperfection in their respective models. The mappings f₁ and f₂ may be linear or non-linear depending on a target phenomenon. As obvious from the expression (1), the state vector Xₜ at the time t does not need to be explicitly described by the state vector Xₜ₋₁ at the time t−1. In other words, the first system model 21-1 and the second system model 21-2 of the present example embodiment may be capable of calculating the state vectors X₁ₜ and X₂ₜ at the time t by using the state vector Xₜ₋₁ at the time t−1 as inputs. Following descriptions are given regarding an update step from the time t−1 to the time t. Although in this example, the number of system models is 2 (i.e. m=2), the number of system models may be appropriately determined on the basis of the target and the number of applicable models.

The ensemble approximation which treats variables of models as the ensemble is described here. Hereinafter, a state vector Xⱼₜ of a system model 21-j (j is an integer from 1 to m) at the time t is, reflecting imperfection of mapping fⱼ representing the system model 21-j and imperfection of input parameter θⱼ, treated as a probability distribution p(Xₜ) instead of the definite value Xⱼₜ. This probability distribution can be represented, using the ensemble approximation, by the ensemble represented in the expression (2).

$$\begin{matrix}[ Math . 2 ] & \\ {\{ {X}_{j , t}^{( i )} \}}_{i = 1}^{N} & ( 2 )\end{matrix}$$

In the example represented in the expression (2), the ensemble is an aggregation of N ensemble members (i.e. an ensemble member X_{j,t}⁽ⁱ⁾, hereinafter also referred to as an ensemble member i). Each of the ensemble members is a state vector. The first system model 21-1 and the second system model 21-2 represented by the expression (1) obtain time evolutions expressed in the expression (3) for all ensemble members i.

[Math. 3]

X_{1,t}⁽ⁱ⁾=f₁(Xₜ₋₁⁽ⁱ⁾,θ₁,v_{1,t})

X_{2,t}⁽ⁱ⁾=f₂(Xₜ₋₁⁽ⁱ⁾,θ₂,v_{2,t}) (3)

This allows calculation of probability distribution of the state vectors X_{1,t} and X_{2,t} at the time t which are calculated in their respective system models. A characteristic is that the calculation in a plurality of system models and of the ensemble represented by the expression (3) is independent for each model and for each ensemble member. Accordingly, when the number of the system models is, for example, m and the number of ensemble members included in the ensemble is N, m×N times of calculation may be repeated, or parallel calculation may be performed. As above, a calculation method can be changed flexibly depending on computing resources. Hereinafter, the probability distribution of the state vector X_{j,t} output from the jth (j=1, . . . , m) system model is represented as “pⱼ(Xₜ)” and referred to as the “prior distribution.” This m prior distributions pⱼ(Xₜ) are stored in the m prior distribution storage units 22 (i.e. the first prior distribution storage unit 22-1 to the mth prior distribution storage unit 22-m). When the ensemble approximation is used, the ensembles which are approximations of the prior distributions is stored as the prior distributions in the m prior distribution storage units 22.

Next, the ensemble update unit 30 is described. The ensemble update unit 30 includes the m posterior distribution generation units 31 (i.e. the first posterior distribution generation unit 31-1 to the mth posterior distribution generation unit 31-m). The m posterior distribution generation units 31 (i.e. the first posterior distribution generation unit 31-1 to the mth posterior distribution generation unit 31-m) read out prior distributions p₁(Xₜ) to pₘ(Xₜ) at the time t from the first prior distribution storage unit 22-1 to the mth prior distribution storage unit 22-m, respectively. Each of the m posterior distribution generation units 31 (i.e. the first posterior distribution generation unit 31-1 to the mth posterior distribution generation unit 31-m) read out the observation data y stored in the observation data storage unit 12. The prior distributions p₁(Xₜ) to pₘ(Xₜ) at the time t are input into the m posterior distribution generation units 31 (i.e. the first posterior distribution generation unit 31-1 to the mth posterior distribution generation unit 31-m) by the first prior distribution storage unit 22-1 to the mth prior distribution storage unit 22-m, respectively. The observation data y stored in the observation data storage unit 12 of the data input unit 10 is input into each of the m posterior distribution generation units 31 (i.e. the first posterior distribution generation unit 31-1 to the mth posterior distribution generation unit 31-m). Each of the m posterior distribution generation units 31 (i.e. the first posterior distribution generation unit 31-1 to the mth posterior distribution generation unit 31-m) calculates a posterior distribution on the basis of the prior distribution and the observation data which are input. For example, posterior distributions in a case where the prior distributions p₁(Xₜ) and p₂(Xₜ) stored in the first prior distribution storage unit 22-1 and the second prior distribution storage unit 22-2 and a distribution p(y) of observation data based on the observation data y are input is referred to as p₁(Xₜ|y) and p₂(Xₜ|y). The posterior distributions p₁(Xₜ|y) and p₂(Xₜ|y) are represented by the expression (4) according to Bayes' theorem.

$$\begin{matrix}[ Math . 4 ] & \\ {p}_{1} ( {X}_{t} \vert y ) = \frac{{p}_{1} ( y \vert {X}_{t} ) {p}_{1} ( {X}_{t} )}{p ( y )} \\ {p}_{2} ( {X}_{t} \vert y ) = \frac{{p}_{2} ( y \vert {X}_{t} ) {p}_{2} ( {X}_{t} )}{p ( y )} & ( 4 )\end{matrix}$$

The m posterior distributions generated by the m posterior distribution generation units 31 (i.e. the first posterior distribution generation unit 31-1 to the mth posterior distribution generation unit 31-m) are also represented by similar expressions. The m posterior distribution generation units 31 (i.e. the first posterior distribution generation unit 31-1 to the mth posterior distribution generation unit 31-m) store the generated posterior distributions in the posterior distribution storage units 32 (i.e. the first posterior distribution storage unit 32-1 to the mth posterior distribution storage unit 32-m), respectively. These m posterior distributions are stored in the posterior distribution storage units 32 (i.e. the first posterior distribution storage unit 32-1 to the mth posterior distribution storage unit 32-m), respectively. When the ensemble approximation is used, the ensembles which are approximations of the posterior distributions are stored in the m posterior distribution storage units 32 as the posterior distributions. The first terms p₁(y|Xₜ) and p₂(y|Xₜ) of the numerators of the right sides of the expression (4) are called as likelihood which is an index of a degree of fitting of the state vector Xₜ to the observation data y. When the observation data y is considered as the normal (i.e. Gaussian) distribution with a variance σ, the likelihood can be calculated for the ensemble member i output from the jth (j=1, . . . , m) system model in accordance with the expression (5).

$$\begin{matrix}[ Math . 5 ] & \\ {λ}_{j , t}^{( i )} = \frac{1}{\sqrt{2 {πσ}^{2}}} exp [ - \frac{{( {y}_{t} - {X}_{j , t}^{( i )} )}^{2}}{2 {σ}^{2}} ] & ( 5 )\end{matrix}$$

Based on the likelihood λ, represented in the expression (5), the log-likelihood L(j) for the whole ensemble (i.e. N ensemble member) during a time period from time k=1 to T can be approximately represented by the expression (6).

$$\begin{matrix}[ Math . 6 ] & \\ L ( j ) ≅ {\sum }_{k = 1}^{T} log ( {\sum }_{i = 1}^{N} {λ}_{j , k}^{( i )} ) - T log N & ( 6 )\end{matrix}$$

This value is called as the model likelihood because this value represents the degree of fitting of the prior distribution pⱼ(X₁) to pⱼ(X_{T}) of time k=1 to T, output from the jth system model, to the observation data. Each of the m posterior distribution generation units 31 (i.e. the first posterior distribution generation unit 31-1 to the mth posterior distribution generation unit 31-m) calculates the value represented by, for example, the expression (6) as the model likelihood. Each of the m posterior distribution generation units 31 (i.e. the first posterior distribution generation unit 31-1 to the mth posterior distribution generation unit 31-m) stores the calculated model likelihood in the model likelihood storage unit 35. The model likelihood storage unit 35 stores results L(1) to L(m) each obtained by calculating the model likelihoods represented by the expression (6) for the prior distributions which are output from the m types of system models and are stored in the first prior distribution storage unit 22-1 to the mth prior distribution storage unit 22-m. When comparing the model likelihoods, sequential model likelihoods at each time t, which are represented by the expression (6-2), can be calculated as the model likelihood instead of calculating the sum of all pieces of time-series data from time k=1 to T, which is represented by the expression (6).

$$\begin{matrix}[ Math . 7 ] & \\ {L}_{t} ( j ) ≅ log ( {\sum }_{i = 1}^{N} {λ}_{j , t}^{( i )} ) - log N & ( 6 \text{-} 2 )\end{matrix}$$

In other words, each of the m posterior distribution generation units 31 (i.e. the first posterior distribution generation unit 31-1 to the mth posterior distribution generation unit 31-m) may calculate, as the model likelihoods, the values represented by the expression (6-2). This method may sometimes be effective when the calculation load of the likelihood is high or depending on the frequency or the reliability of the observation data. As described above, although the likelihood and the model likelihood can be calculated according to the expression (5) and the expression (6) or (6-2), these expressions are merely examples. Especially when the observation data is not following the normal (i.e. Gaussian) distribution, this does not apply in practice. As a method for calculating the likelihood and the model likelihood, a suitable calculation method can be used each time.

The posterior distribution weight determination unit 33 reads the posterior distributions each stored in the posterior distribution storage units 32 (i.e. the first posterior distribution storage unit 32-1 to the mth posterior distribution storage unit 32-m) and each derived through time evolution calculations in the system models. The posterior distribution weight determination unit 33 further reads the model likelihoods, stored in the model likelihood storage unit 35, of the system models. The posterior distribution weight determination unit 33 receives the posterior distributions each derived through the time evolution calculations in the system models and the model likelihoods, stored in the model likelihood storage unit 35, of the respective system models. The posterior distribution weight determination unit 33 generates new posterior distributions p′₁(Xₜ|y) to p′ₘ(Xₜ|y) obtained by weighting the posterior distributions p₁(Xₜ|y) to pₘ(Xₜ|y) by using the model likelihoods L(1) to L(m) as references. The posterior distribution weight determination unit 33 stores the new posterior distributions p′₁(Xₜ|y) to p′ₘ(Xₜ|y) in the input distribution storage units 34 (i.e. the first input distribution storage unit 34-1 to the mth input distribution storage unit 34-m), respectively. The posterior distribution weight determination unit 33 outputs a superposition of the new posterior distributions at each time step to the data output unit 40, and stores the superposition of the new posterior distributions in the time series state vector storage unit 41. The superposition of the new posterior distribution is described later.

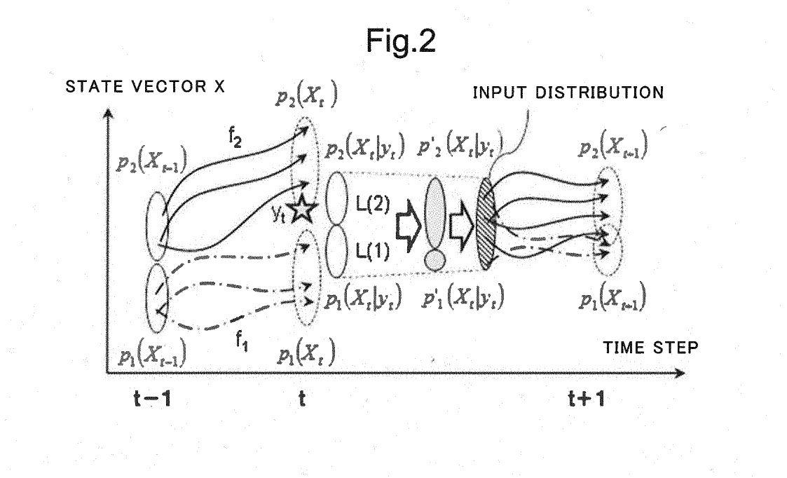

A method for generating the model likelihoods and the new posterior distributions in the posterior distribution weight determination unit 33 is described by taking an example. FIG. 2 illustrates a conceptual diagram of the operation example. The horizontal axis represents the time steps and the vertical axis represents values of the state vector X. Hereinafter, the represented as an example is a case in which the system models 21 included in the model ensemble unit 20 is the first system model 21-1 and the second system model 21-2. First, the state vector at the time t−1 is input to each of the system models (i.e. the first system model 21-1 and the second system model 21-2). The input distributions which are distributions of state vectors and are input to each of the system model is represented as p₁(Xₜ₋₁) and p₂(Xₜ₋₁). The first system model 21-1 derives the prior distribution p₁(Xₜ) at the time t to which the time step is proceeded on the basis the input distribution p₁(Xₜ₋₁) by using mappings f₁ and f₂ representing the transformation by the first system model 21-1. The second system model 21-2 derives the prior distribution p₂(Xₜ) at the time t to which the time step is proceeded on the basis of the input distribution p₂(Xₜ₋₁) by using mappings f₁ and f₂ representing transformation by the second system model 21-2. By inputting the prior distribution p₁(Xₜ) and the observation data yₜ at the time t to the first posterior distribution generation unit 31-1, the posterior distribution p₁(Xₜ|yₜ) and the model likelihood L(1) are obtained. By inputting the prior distribution p₁(Xₜ) and the observation data yₜ at the time t to the second posterior distribution generation unit 31-2, the posterior distribution p₂(Xₜ|yₜ) and the model likelihood L(2) are obtained. The first posterior distribution generation unit 31-1 derives the posterior distribution p₁(Xₜ|yₜ) and the model likelihood L(1) on the basis of the prior distribution p₁(Xₜ) and the observation data yₜ at the time t. The second posterior distribution generation unit 31-2 derives the posterior distribution p₂(Xₜ|yₜ) and the model likelihood L(2) on the basis of the prior distribution p₂(Xₜ) and the observation data yᵣ at the time t. Here it is assumed that, as illustrated in FIG. 2, the posterior distribution p₂(Xₜ|yₜ) by the mapping f₂ representing the second system model 21-2 is closer to the observation data yᵣ than the posterior distribution p₁(Xₜ|yₜ) by the mapping f₁ representing the first system model 21-1 is. In other words, the assumed is that the magnitude relationship of the model likelihoods is L(1)<L(2). Then, the original posterior distributions and the new posterior distributions p′₁(Xₜ|y) and p′₂(Xₜ|y) generated by the posterior distribution weight determination unit 33 are calculated in accordance with the expression (7) using weighting factors α1 and α2 which are functions of the model likelihood.

[Math. 8]

p′₁(Xₜ|y)=α₁(L(1))·p₁(Xₜ|y)

p′₂(Xₜ|y)=α₂(L(2))·p₂(Xₜ|y) (7)

Especially, because of the magnitude relationship between the model likelihoods L(1)<L(2), the magnitude relationship between the weighting factors is also α1<α2. The sum of all weighting factors satisfies the relationship represented in the expression (8).

$$\begin{matrix}[ Math . 9 ] & \\ {\sum }_{j = 1}^{m} {α}_{j} \leq 1 & ( 8 )\end{matrix}$$

The expression (8) means that the integrated value of a new generated posterior distribution is equal to or smaller than the integrated value of an original posterior distribution. According to the ensemble approximation represented in the expression (2), the total number (hereinafter, also referred to as “total”) of the ensemble members of the generated new posterior distributions with respect to all the system models is equal to or smaller than the total number of the ensemble members of the original posterior distributions. In other words, the total of the ensemble members is preserved or decrease in the total is allowed.

The expressions (7) and (8) regarding the weighting factor αⱼ are described more generally. The weighting factor αⱼ is determined based on m types of model likelihoods L(j) (j=1, . . . , m). As described above, for example, a weighting factor may be defined such that the weighting factor is larger as the model likelihood thereof is larger. The weighting factor may be defined by, for example, a proportional relationship between the model likelihoods and the weighting factors. The relationship between the model likelihoods and the weighting factors may be represented by, for example, a monotonically increasing linear function or non-linear function. The posterior distribution weight determination unit 33 may determine the weighting factor αj such that the sum total of the weighting factors represented by the expression (8) decreases when the sum total of the model likelihoods is sufficiently large, and otherwise, is preserved. Decrease in the sum total of the weighting factors corresponds to decrease in the total number of the ensemble members (hereinafter, also referred to as the number of ensemble members). Preserving the sum total of the weighting factors corresponds to preserving the total number of the ensemble members. The number of ensemble members relate to the number of iterative calculations, i.e., the amount of calculation. Accordingly, when the model likelihood of the system model is large, i.e., when the system model is more probable if compared with the observation data, by reducing the number of ensemble members input to the system model, the amount of calculations can be reduced. When the model likelihood of the system model is small, i.e., when the system model may not be determined to be clearly probable if compared with the observation data, the accuracy of the calculation can be kept by preserving the number of ensemble members input to the system models. The above described determination method of the weighting factors is merely an example. In practice, the determination method of the weighting factor is not limited thereto.

Next, following descriptions are given using an example represented in FIG. 2 regarding the input distributions stored in the input distribution storage unit 34 and the input distributions input to m system models 21 (i.e. the first system model 21-1 to the mth system model 21-m). In the example represented in FIG. 2, the new posterior distributions p′1(Xt|y) and p′2(Xt|y) as they are, which are generated by the posterior distribution weight determination unit 33, include large deviation from values of the state vector. As above, it is probable that the new posterior distribution generated by the posterior distribution weight determination unit 33 includes large deviation. When calculation for a proceeded time step is continued, deviated posterior distributions are continually input into each of the system models. For this reason, the variance of the state vector becomes large. This leads to increase in the generalization error. In the present example embodiment, the posterior distribution weight determination unit 33 stores the p′1(Xt|y)∪p′2(Xt|y) which is the sum of the new posterior distributions p′1(Xt|y) and p′2(Xt|y) in the input distribution storage unit 34 as an input distribution.

For example, the posterior distribution weight determination unit 33 generates distributions read out as input by the first system model 21-1 and the second system model 21-2 by random sampling from the input distribution as described below. The posterior distribution weight determination unit 33 stores the generated distribution in the input distribution storage unit 34. The first system model 21-1 and the second system model 21-2 read out the determined distributions from the input distribution storage unit 34. The first system model 21-1 and the second system model 21-2 use the read distributions for the calculation at the next time step. In the following description, the distribution read out as input by the first system model 21-1 is referred to as “a first distribution.” Similarly, the distribution read as input by the second system model 21-2 is referred to as “a second distribution.”

Specifically, the posterior distribution weight determination unit 33 generates the first distribution by random sampling from the input distribution such that the integrated value of the first distribution is equal to the integrated value of the new generated posterior distribution p′1(Xt|y). Similarly, the posterior distribution weight determination unit 33 generates the second distribution by the random sampling from the input distribution such that the integrated value of the second distribution is equal to the integrated value of the new posterior distribution p′2(Xt|y) generated by the posterior distribution weight determination unit 33. When the ensemble approximation is used, the posterior distribution weight determination unit 33 selects ensemble members by random sampling from the sum p′1(Xt|y)∪p′2(Xt|y) such that the sum total of the ensemble members becomes p′1(Xt|y). The posterior distribution weight determination unit 33 stores the selected ensemble members in the input distribution storage unit 34 as a first distribution. The first system model 21-1 reads out the selected ensemble members (i.e., the first distribution) from the input distribution storage unit 34 as input. Similarly, the posterior distribution weight determination unit 33 selects, from the sum p′1(Xt|y)∪p′2(Xt|y), the ensemble members by random sampling such that the sum total of the ensemble members becomes p′2(Xt|y). The posterior distribution weight determination unit 33 stores the selected ensemble members in the input distribution storage unit 34 as a second distribution. The second system model 21-2 reads out the selected ensemble members (i.e., the second distribution) from the input distribution storage unit 34 as input.

In the example represented in FIG. 2, the model likelihood of the second system model 21-2 is higher than the model likelihood of the first system model 21-1. In that case, the first system model 21-1 performs random sampling such that the number of ensemble members input into the first system model 21-1 is smaller than the number of ensemble members input into the second system model 21-2 having the higher model likelihood.

The posterior distribution weight determination unit 33 outputs, to the data output unit 40, the superposition, represented in the expression (9), of the new posterior distributions at each time step to the data output unit 40.

[Math. 10]

α₁(L(1))·p₁(Xₜ|y)+α₂(L(2))·p₂(Xₜ|y) (9)

In other words, the posterior distribution weight determination unit 33 stores the superposition, represented by the expression (9), of the new posterior distributions at each time step in the time series state vector storage unit 41. As above, the time series state vector storage unit 41 stores the superposition, represented by the expression (9), of the new posterior distributions for each time step from the start to the end of the simulation as a simulation result. The output unit 42 reads out the simulation result stored in the time series state vector storage unit 41 in response to a request from, for example, a terminal device (not illustrated), and outputs the read simulation result to the terminal device.

An operation of the simulation device 100 according to the first example embodiment represented in FIG. 1 are described in details with reference to drawings.

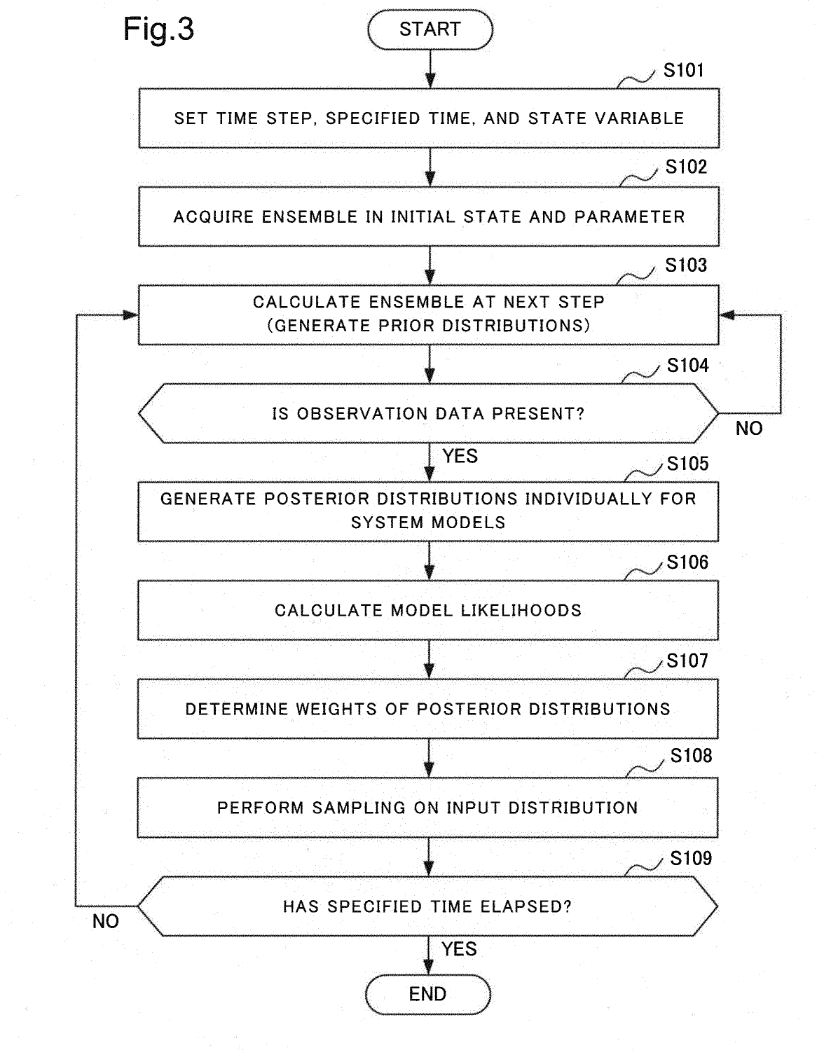

FIG. 3 is the flowchart representing the operation example of the simulation device 100 according to the present example embodiment. Prior to the operations illustrated in FIG. 3, for example, a user of the simulation device 100 inputs conditions necessary for performing a simulation (i.e. an object simulation) executed by the simulation device 100 by using, for example, a terminal device or the like (not illustrated). The acquisition unit 14 receives the input conditions necessary for performing the object simulation, and stores the conditions necessary for performing the object simulation in the simulation condition storage unit 11. The conditions necessary for performing the simulation is described later. Similarly, the user inputs observation data used for the simulation into the simulation device 100 by using the terminal device or the like. The acquisition unit 14 stores the input observation data in the observation data storage unit 12. The simulation device 100 starts the simulation in accordance with instructions by the user through the terminal device or the like.

When the simulation device 100 start the simulation, first, each of the m system model 21s reads the conditions necessary for performing the object simulation from the simulation condition storage unit 11, for example, via the initial setting unit 13. The conditions necessary for performing the simulation is, for example, a time step, a specified time until the end, and a state variable for which a time evolution is obtained. Each of the m system models 21 sets the read conditions necessary for performing the object simulation as the conditions used for the simulation (step S101). Each of the system models 21 stores the time step, the specified time until the end, and the state variable which are set in the simulation condition storage unit 11. Next, the initial setting unit 13 generates ensemble in an initial state and parameters on the basis of information stored in the simulation condition storage unit 11. One, which is selected, for example, in advance, of the m system models 21 may operate as the initial setting unit 13. The initial setting unit 13 further inputs the ensemble in the initial state and the parameter into each of the m system models 21 (i.e. the first system model 21-1 to the mth system model 21-m) (step S102). Then, each of the system models 21 calculates ensembles at a next step, i.e., prior distributions (step S103). At the time of this step, the m posterior distribution generation units 31 (i.e. the first posterior distribution generation unit 31-1 to the mth posterior distribution generation unit 31-m) determine whether the observation data is obtained (step S104). When the observation data is absent (NO in step S104), the processing of the simulation device 100 returns to step S103. At step S103, the prior distributions each are returned to the system model 21, and the time step is incremented by one. In other words, in step S103, each of the system models 21, for example, increments a time step by one, and calculates the ensemble at the time step. When the observation data is present (YES in step S104), the processing of the simulation device 100 proceeds to a next step (step S105).

Each of the m posterior distribution generation units 31 independently generates the posterior distribution based on the prior distributions calculated by the m system models 21 (step S105). As described above, the m posterior distribution generation units 31 are from the first posterior distribution generation unit 31-1 to the mth posterior distribution generation unit 31-m. The m system models 21 are from the first system model 21-1 to the mth system model 21-m. Thereafter, the m posterior distribution generation units 31 further calculate model likelihoods (step S106). The posterior distribution weight determination unit 33 determines posterior distribution weights on the basis of the calculated model likelihoods (step S107). The posterior distribution weight determination unit 33 generates an input distribution which is input at the next time step by sampling (step S108). The posterior distribution weight determination unit 33 stores the input distribution which is generated by sampling and is the input at the next time step in the input distribution storage unit 34. The posterior distribution weight determination unit 33 stores, in the time series state vector storage unit 41, a simulation result generated by superposition of the posterior distributions in which the determined weights are reflected. The data output unit 40 may transmit the simulation result stored in the time series state vector storage unit 41 to the terminal device in accordance with the user's instructions input through the above described terminal device (not illustrated).

When the specified time has elapsed after the start of the simulation (YES in step S109), for example, when the number of time steps reaches the specified number of steps, the operations illustrated in FIG. 3 (i.e., the simulation) end. When the specified time has not been elapsed after the start of the simulation (NO in step S109), for example, when the number of time steps has not reached the specified number of steps, the processing of the simulation device 100 returns to step S103. At step S103, the input distributions each being suited to the system models 21 are input into their respective m system models 21 (i.e. the first system model 21-1 to the mth system model 21-m) from the input distribution storage unit 34. For example, each of the m system models 21 reads out an input distributions calculated on the basis of the calculated posterior distribution from the input distribution storage unit 34. The m system models 21 start the calculation at the next step.

The present example embodiment described above has effects of improving both the predicting capability and the calculation resource efficiency.

The reason is because the posterior distribution weight determination unit 33, for at least two different models, determines the weights for the posterior distributions on the basis of the posterior distributions and the model likelihoods. The posterior distributions, which are calculated independently for two different models by the model ensemble units 20, are posterior distributions, based on the observation data, of the time evolutions of the state vectors as input. The model likelihoods are values representing the likelihoods of the models on the basis of the observation data. The posterior distribution weight determination unit 33 further calculates input distributions representing the state vectors as input to the model ensemble unit 20 at a next time step on the basis of the determined weights and the posterior distributions. In the present example embodiment, the time evolution of the state vector, the posterior distribution, the model likelihood, and the next input distribution can be calculated independently for each model. Accordingly, the parallelization of processes is possible. When the model likelihood is large, by reducing the sum total of the weighting factors determined by the posterior distribution weight determination unit 33, i.e., by reducing the total number of the ensemble members, the amount of calculation can be reduced. As above, the resource efficiency can be improved. In the present example embodiment, the posterior distribution weight determination unit 33 calculates the state vectors represented as the input distributions on the basis of the weight based on the model likelihood and the posterior distribution for each model. For example, the predicting capability can be improved by determining a weight such that, for example, the weight of the model is larger as the model likelihood is larger, and the weight of the model is smaller as the model likelihood is smaller.

### Second Example Embodiment

Next, the second example embodiment of the present invention is described with reference to the drawings. The simulation device 200 of the present example embodiment is achieved by applying the simulation device 100 of the first example embodiment to simulation of growth (i.e. growing) of crops. By performing the simulation for the growth (growing) of crops, farming support information can be provided with agriculture agencies or farmers as targets. In drawings which are referred to in the description of the second example embodiment of the present invention below, components and steps similar to those of the first example embodiment of the present invention are denoted with identical reference signs, and detailed descriptions in the present example embodiment are omitted.

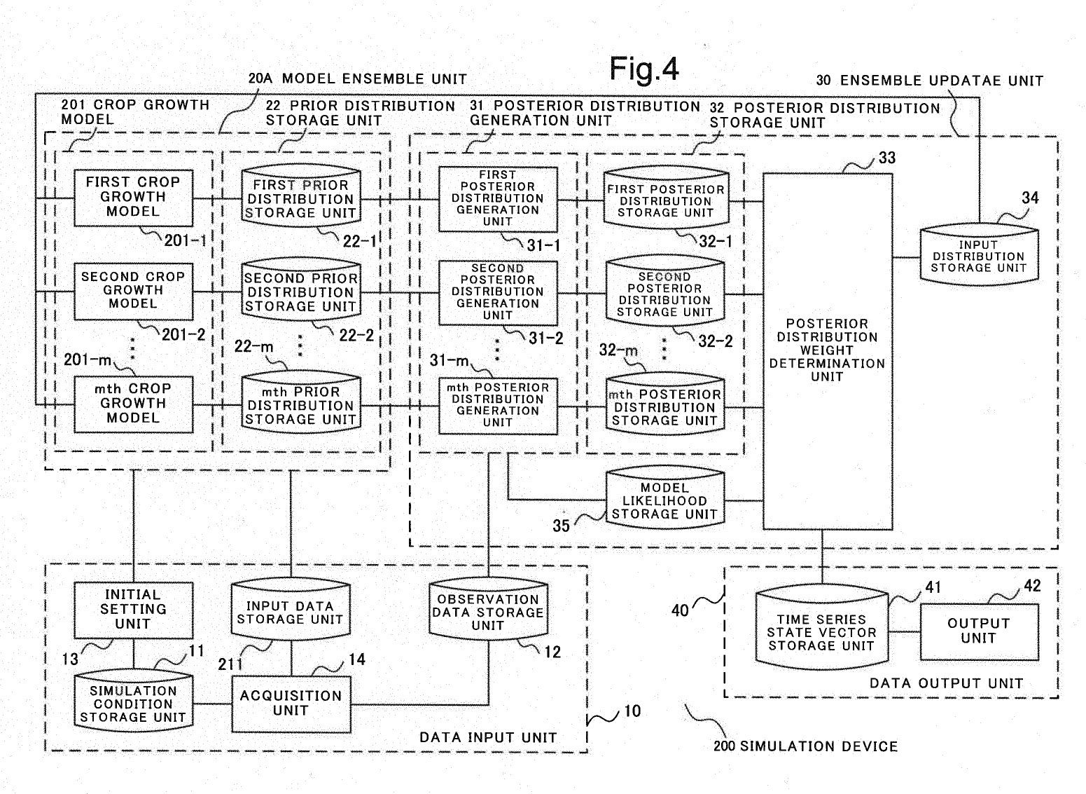

First, FIG. 4 illustrates a configuration of the simulation device 200 of the second example embodiment of the present invention. FIG. 4 is a block diagram illustrating a configuration of the simulation device 200 of the present example embodiment. Comparing FIG. 4 with FIG. 1 illustrating a configuration of the simulation device 100 of the first example embodiment, the simulation device 200 of the present example embodiment includes, instead of the data input unit 10 and the model ensemble unit 20, a data input unit 210 and the model ensemble unit 20A. Comparing the model ensemble unit 20A with the model ensemble unit 20, the model ensemble unit 20A includes, instead of the system model 21, a crop growth model 201. The crop growth model 201 includes m crop growth models (i.e. a first crop growth model 201-1 to an mth crop growth model 201-m). Comparing the data input unit 210 with the data input unit 10, the data input unit 210 further includes an input data storage unit 211.

As described above, the simulation device 100 according to the first example embodiment of the present invention includes the m system models 21 (i.e. the first system model 21-1 to the mth system model 21-m). As illustrated in FIG. 4, the simulation device 200 includes, instead of the m system models 21, the m crop growth models 201 (i.e. the first crop growth model 201-1 to the mth crop growth model 201-m). The m crop growth models 201 of the present example embodiment correspond to the m system models 21 specialized for the simulation of the crop growth (i.e. growing). In other words, the m crop growth models 201 of the present example embodiment are the m system models 21 applied to the simulation of the crop growth (i.e. growing). The simulation condition storage unit 11 of the data input unit 210 stores, as specific simulation conditions, parameters and the like which characterize, for example, an initial state of soil, a landform and crops. In the present example embodiment, the data input unit 210 of the simulation device 200 further includes the input data storage unit 211. The input data storage unit 211 stores time-series weather data, soil moisture amount data and the like which can be obtained through various types of field sensors or as public information. The required simulation conditions and input data depend on a specification of individual crop growth model. Therefore, the simulation condition storage unit 11 may store the simulation conditions and the like which are suitable for the crop growth model, depending on the crop growth model that is used. The observation data storage unit 12 stores, as the specific observation data, remote sensing data, camera images and the like which represent a growth state of the crops and are captured using a satellite or an aircraft. Other configurations are similar to those of the simulation device 100 of the first example embodiment, and thus, the description is omitted.

In the present example embodiment, Normalized Difference Vegetation Index (NDVI) which is generally used as a vegetation index can be used as the observation data representing the growth state of the crops. This value can be calculated from reflectances of two bands, i.e., a visible red band and a near-infrared band. In the present example embodiment, Leaf Area Index (LAI) can be used as a state vector in the crop growth model 201. The LAI is known to be correlated with the NDVI. Such LAI is calculated by the crop model 201 on the basis of, for example, parameters of an initial state of soil, a landform and crops, and simulation conditions and parameters such as weather data. The simulation conditions and the parameters used for calculation of LAI may be stored in the simulation condition storage unit 11 or the input data storage unit 211 in advance, and may be read out by the crop growth model 201. However, information used as the observation data and the state vectors are not limited to these values.

NDVI as the observation data can be calculated on the basis of data which can be obtained from, for example, a sensor Moderate Resolution Imaging Spectroradiometer (MODIS; Terra/Aqua MODIS) mounted on Terra satellite or Aqua satellite. In details, the data of the strength of reflected light of the sunlight in the visible red band (wavelength 0.58-0.86 μm) and the near-infrared band (wavelength 0.725-1.100 μm) by the Terra/Aqua MODIS is available. Although this data can be obtained basically every day, the spatial resolution on the ground is about 250 m and is low. Data obtained from Landsat satellite, Pleades satellite, Advanced Satellite with New system Architecture for Observation (ASNARO) satellite and the like can be used. Available wavelength regions of these are almost identical with the above described wavelength regions. However, acquisition frequencies and ground resolutions are about 30 m and 8 to 16 days intervals in the case of Landsat satellite, and about 2 m and 2 to 3 days intervals in the cases of Pleades satellite and ASNARO satellite. The camera images may be images representing the strength in the visible red band and the near-infrared band, which are described above. However, the wavelength regions where the observation data of the present example embodiment is observed is not necessarily limited to these bands.

For example, Decision Support System for Agrotechnology Transfer (DSSAT), the Agricultural Production Systems simulator (APSIM), WOrld FOod Studies (WOFOST) and the like can be used as a model that a plurality of crop growth models 201 conform to. The degree of fitting of a model to an actual environment is calculated as a quantitative and objective index that is the model likelihood by the posterior distribution generation unit 31, and is stored in the model likelihood storage unit 35. In agriculture, especially in open-field cultivation, the number of times a crop grows is one time a year, or at most two to three times a year. Since conditions of soil and a crop kind, which are required for the simulation, are various and large in numbers, and are often not easy to be obtained. Information accumulated for the model likelihood can be used, for example, when the observation data representing a growth state of crops is insufficient at an early stage of the start of cultivation in a following year. The model likelihoods regarding a combination of a territory and a crop are accumulated. By accumulating data each time performing expansion into another territory and another crop, it is possible to create a database allowing quantitative and objective determination on strengths and weaknesses of each crop growth model for a territory and a crop.

Concerning the model ensemble unit 20A using a plurality of crop growth models 201, effects other than getting over strengths and weaknesses for a territory and a crop are described. In recent years, changes in climate and weather such as global heating and sudden torrential rainfall become apparent. Especially, agriculture with open-field cultivation is largely influenced by weather. Accordingly, in providing farming support information by the simulation, it is necessary to accurately show the influence (especially, bad influence) of weather on crop growth. Bad influences of weather on crop growth specifically include water shortage stress and high temperature stress due to continuation of a drought, and excess water stress due to sudden torrential rainfall. However, since calculation accuracy of bad influence of weather on crop growth largely depends on the crop growth models, a weather state which is not considered in the model is not reflected on a result of the calculated simulation. A plurality of crop growth models 201 of the present example embodiment are capable of performing calculation according to different models. For example, it is possible to use three different crop growth models 201 that perform calculations of influences according to, for example, models suitable for the weather state in reality: a model having a high calculation accuracy under the water shortage stress; a model having a high calculation accuracy under the high temperature stress; and a model having a high calculation accuracy under the excess water stress. Accordingly, in the present example embodiment, the predicting capability may be improved compared to a case of using a single model by using a plurality of different system models. As above, the ability to design a combination of a plurality of system models so as to be adaptable to the change in the real world is also the feature of the present invention.

Following describes the effect obtained by leaving a model as a component of model ensemble even if the likelihood of the model is low, i.e., the weight of the model is small. Generally, it is considered that the predicting capability can be preserved if at least a model having a high likelihood, i.e., having a large weight is left. However, next two effects can be exerted by using a plurality of different system models at the application destination, such as the crop growth models exemplified in the present example embodiment, having a high uncertainty caused by influence of environment and individual difference. The first effect is a point that the uncertainty in the individual system models is cancelled out by dealing with a plurality of system models as the model ensemble of the present example embodiment. The second effect is a point that a plurality of system models include system models having different prediction values so that while the model ensemble of the present example embodiment reduces the variance and the bias, the prediction values may have a certain degree of range, i.e., distribution. This allows not only the deterministic prediction, but also the prediction of the stochastic scenario.

The simulation device 200 according to the second example embodiment of the present invention is the simulation device 100 of the first example embodiment applied to the simulation of the growth of the crops. Specifically, the crop growth models 201 are the system models 21 applied to the simulation of the growth of the crops. The observation data according to the second example embodiment is the data representing the growth state of crops. These are merely examples. The present invention is not limited to these examples. A model that the system models 21 conform to may be appropriately selected depending on the object to be applied. The present example embodiment is also applicable to another combination of a simulation model and observation data. A combination of a simulation model and observation data may be, for example, a combination of a water dynamics and fluid model, and the water level sensor data of the rivers and the satellite data, a combination of a biological object and human body model, and medical data or health care data, a combination of a weather model and, the weather sensor data or satellite data, or the like.

In the above descriptions, the model that the system models 21 conform to is a deductive model already given with a model expression based on a physical law, a theory, a function and the like. As such a model, there are, for example, the partial differential equations, based on the physical law, of the continuous time the space described in the first example embodiment, and the crop growth model, the water dynamics and fluid model, the biological object and human body model, and the weather model which are described in the second example embodiment. However, the model that the system models 21 conform to may be, for example, a model recursively generated on the basis of some sort of data, or an inductive model generated by the machine learning or the like. For example, it is not easy to make a model expression based on a physical law or a theory for the purchase behavior with which humans participate and a transition of the market prices. However, by using the inductive model, it is possible to represent, by a model, an object for which a model expression based on a physical law or a theory is not made easily. For example, objects such as purchase behavior which humans participate and a transition of a market price can be represented by the inductive models such as purchase model and a transition model of a market price. In other words, by using the inductive model, it is possible to apply each of the simulation devices of the example embodiments of the present invention to an object for which a model expression based on a physical law or a theory is not made easily. A deductive model and an inductive model may be used in combination. Using a combination of a deductive model and a inductive model, an object which may not be accurately represented by any one of models alone is expected to be represented accurately.

The present example embodiment described above has effects that are the same as those of the first example embodiment. Reasons are similar to reasons why the effects of the first example embodiment arise.

Next, the third example embodiment of the present invention is described in details with reference to drawings.

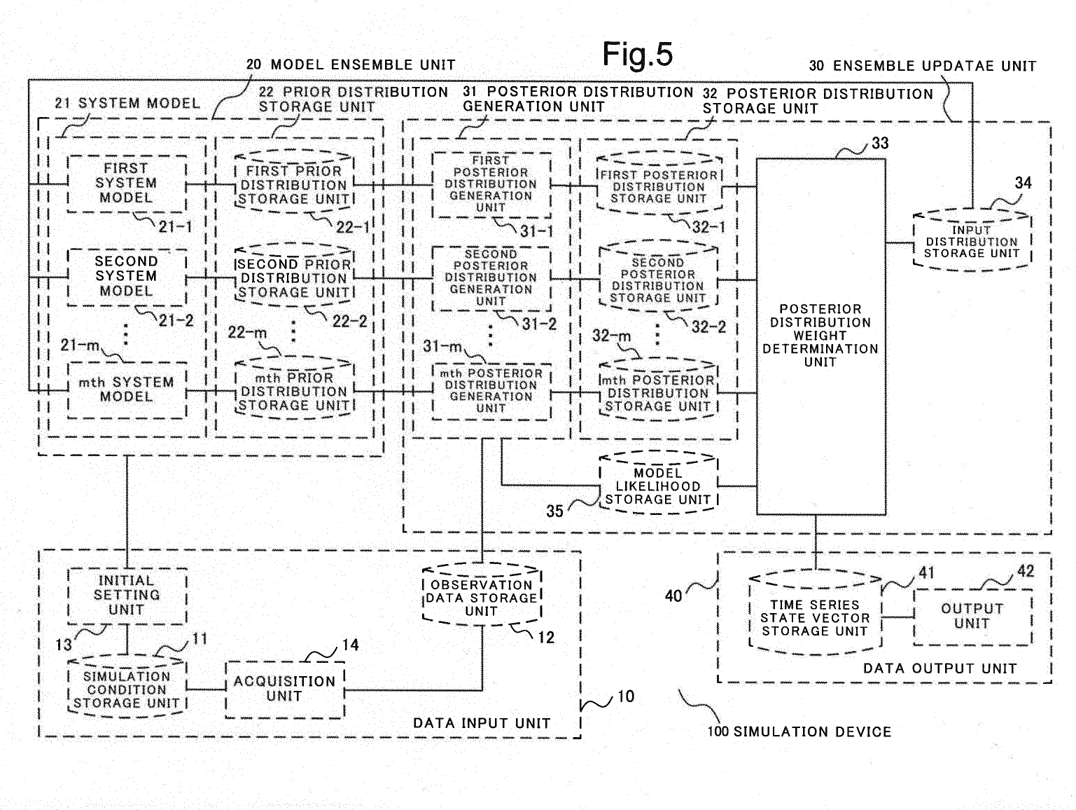

FIG. 5 is a block diagram illustrating a configuration example of the simulation device 300 of the present example embodiment. Referring to FIG. 5, the simulation device 300 of the present example embodiment includes the model ensemble unit 20, the posterior distribution generation unit 31, and the posterior distribution weight determination unit 33. The model ensemble unit 20, on the basis of a state vector as input, calculates time evolutions of the state vector with respect to at least two different models by simulation according to the models. The posterior distribution generation unit 31, based on the time evolutions of the state vector and observation data, generates posterior distributions of the time evolutions of the state vector and model likelihoods which are the likelihoods, based on the observation data, of the model. The posterior distribution weight determination unit 33, based on the posterior distributions and the model likelihoods, determines weights of the posterior distributions, and based on the weights and the posterior distributions, calculates a next state vector.

The present example embodiment described above has effects that are the same as those of the first example embodiment. Reasons are similar to reasons why the effects of the first example embodiment arise.

Each of the simulation devices 100, 200 and 300 can be achieved by a computer and a program controlling the computer, dedicated hardware, or a combination of a computer and a program controlling the computer, and dedicated hardware.

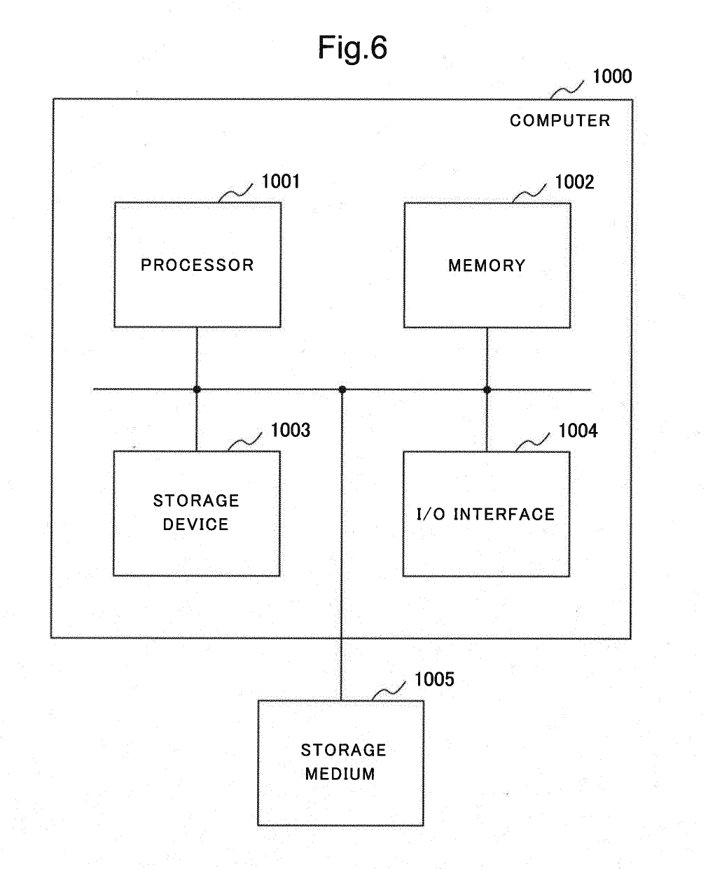

FIG. 6 is a drawing representing an example of a hardware configuration of the computer 1000 with which the simulation devices 100, 200 and 300 can be achieved. Referring to FIG. 6, the computer 1000 includes a processor 1001, a memory 1002, a storage device 1003, and an Input/Output (I/O) interface 1004. The computer 1000 can access a storage medium 1005. The memory 1002 and the storage device 1003 are, for example, storage devices such as Random Access Memory (RAM) and a hard disk. The storage medium 1005 is, for example, the storage device such as RAM and hard disk, Read Only Memory (ROM), and a portable storage medium. The storage device 1003 may be the storage medium 1005. The processor 1001 can read/write data and a program from/to the memory 1002 and the storage device 1003. The processor 1001 can access, for example, a server device, a terminal device and the like (not illustrated) via the I/O interface 1004. The processor 1001 can access the storage medium 1005. The storage medium 1005 stores a program which causes the computer 1000 to operate as the simulation device 100, 200 or 300.

The processor 1001 loads, into the memory 1002, the program which is stored in the storage medium 1005 and causes the computer 1000 to operate as the simulation device 100, 200 or 300. By the processor 1001 executing the program loaded to the memory 1002, the computer 1000 operates as the simulation device 100, 200 or 300.

Units included in a first group can be achieved by, for example, a dedicated program which is loaded into the memory 1002 from the storage medium 1005 storing a program and can achieve functions of the units, and the processor 1001 that executes the program. The first group includes the initial setting unit 13, the acquisition unit 14, the system model 21, the posterior distribution generation unit 31, the posterior distribution weight determination unit 33, the output unit 42, and the crop model 201. Units in a second group can be achieve by the memory 1002 and the storage device 1003 such as a hard disk device which are included in the computer 1000. The second group includes the simulation condition storage unit 11, the observation data storage unit 12, the prior distribution storage unit 22, the posterior distribution storage unit 32, the input distribution storage unit 34, the model likelihood storage unit 35, the time series state vector storage unit 41, and the input data storage unit 211. Alternatively, a part or the whole of units included in the first group and units included in the second group can be achieved by a dedicated circuit which achieve functions of the units.

A part or the whole of the above described example embodiments can be described as Supplementary Notes below, but is not limited thereto.

### (Supplementary Note 1)

A simulation device including:

model ensemble means for calculating, based on a state vector as an input, time evolutions of the state vector by simulation according to models, for at least two different models;

posterior distribution generation means for generating, based on the time evolutions of the state vector and observation data, posterior distributions of the time evolutions of the state vector and model likelihoods that are likelihoods, based on the observation data, of the models; and

posterior distribution weight determination means for determining, based on the posterior distributions and the model likelihoods, weights of the posterior distributions, and calculating, based on the weights and the posterior distributions, a next state vector of the state vector.

### (Supplementary Note 2)

The simulation device according to Supplementary Note 1, wherein

the posterior distribution generation means calculates model likelihoods sequentially based on observation data obtained before the posterior distributions are generated or based on newly obtained observation data.

### (Supplementary Note 3)

The simulation device according to Supplementary Note 1 or 2, wherein

the posterior distribution weight determination means determines the weights such that the weights are proportional to the model likelihoods.

### (Supplementary Note 4)

The simulation device according to any one of Supplementary Notes 1 to 3, wherein

the model ensemble means calculates, based on input distributions, probability distributions as time evolutions of the state vector, the input distributions being probability distributions that approximate the state vector as an input; and

the posterior distribution weight determination means calculates, based on the posterior distributions and the weights, the input distributions as the next state vector.

### (Supplementary Note 5)

The simulation device according to Supplementary Note 4, wherein

the posterior distribution weight determination means updates the posterior distributions by using the weights, generates a superposition of the updated posterior distributions, and generates the input distribution as a distribution sampled from the superposition.

### (Supplementary Note 6)

The simulation device according to any one of Supplementary Notes 1 to 5, wherein

the models are deductive models generated theoretically or inductive models generated based on data.

### (Supplementary Note 7)

The simulation device according to any one of Supplementary Notes 1 to 6, wherein

the posterior distribution weight determination means determines the weights such that a sum total of the weights is equal to or smaller than one.

### (Supplementary Note 8)

The simulation device according to any one of Supplementary Notes 1 to 7, including:

acquisition means for acquiring a simulation condition that is a condition at the simulation, an initial state of the state vector, and the observation data; and

output means for outputting time-series of the state vector.

### (Supplementary Note 9)

A simulation method including:

calculating, based on a state vector as an input, time evolutions of the state vector by simulation according to models, for at least two different models;

generating, based on the time evolutions of the state vector and observation data, posterior distributions of the time evolutions of the state vector and model likelihoods that are likelihoods, based on the observation data, of the models; and

determining, based on the posterior distribution and the model likelihood, weights of the posterior distributions, and calculating, based on the weights and the posterior distributions, a next state vector of the state vector.

### (Supplementary Note 10)

The simulation method according to Supplementary Note 9, including

calculating model likelihoods sequentially based on observation data obtained before the posterior distributions are generated or based on newly obtained observation data.

### (Supplementary Note 11)

The simulation method according to Supplementary Note 9 or 10, including

determining the weights such that the weights are proportional to the model likelihoods.

### (Supplementary Note 12)

The simulation method according to any one of Supplementary Notes 9 to 11, including:

calculating, based on input distributions, probability distributions as time evolutions of the state vector, the input distributions being probability distributions that approximate the state vector as an input; and

calculating, based on the posterior distributions and the weights, the input distributions as the next state vector.

### (Supplementary Note 13)

The simulation method according to Supplementary Note 12, including:

updating the posterior distributions by using the weights, generating a superposition of the updated posterior distributions, and generating the input distribution as a distribution sampled from the superposition.

### (Supplementary Note 14)

The simulation method according to any one of Supplementary Notes 9 to 13, wherein

the models are deductive models generated theoretically or inductive models generated based on data.

### (Supplementary Note 15)

The simulation method according to any one of Supplementary Notes 9 to 14, including

determining the weights such that a sum total of the weights is equal to or smaller than one.

### (Supplementary Note 16)

The simulation method according to any one of Supplementary Notes 9 to 15, including:

acquiring a simulation condition that is a condition at the simulation, an initial state of the state vector, and the observation data; and

outputting time-series of the state vector.

### (Supplementary Note 17)

A program that causes a computer to operate as:

model ensemble means for calculating, based on a state vector as an input, time evolutions of the state vector by simulation according to models, for at least two different models;

posterior distribution generation means for generating, based on the time evolutions of the state vector and observation data, posterior distributions of the time evolutions of the state vector and model likelihoods that are likelihoods, based on the observation data, of the models; and

posterior distribution weight determination means for determining, based on the posterior distributions and the model likelihoods, weights of the posterior distributions, and calculating, based on the weights and the posterior distributions, a next state vector of the state vector.

### (Supplementary Note 18)

The program according to Supplementary Note 17, further causing a computer to operate as:

the posterior distribution generation means that calculates model likelihoods sequentially based on observation data obtained before the posterior distributions are generated or based on newly obtained observation data.

### (Supplementary Note 19)

The program according to Supplementary Note 17 or 18, further causing a computer to operate as:

the posterior distribution weight determination means that determines the weights such that the weights are proportional to the model likelihoods.

### (Supplementary Note 20)

The program according to any one of Supplementary Notes 17 to 19, further causing a computer to operate as:

the model ensemble means that calculates, based on input distributions, probability distributions as time evolutions of the state vector, the input distributions being probability distributions that approximate the state vector as an input; and

the posterior distribution weight determination means that calculates, based on the posterior distributions and the weights, the input distributions as the next state vector.

### (Supplementary Note 21)

The program according to Supplementary Note 20, further causing a computer to operate as:

the posterior distribution weight determination means that updates the posterior distributions by using the weights, generates a superposition of the updated posterior distributions, and generates the input distribution as a distribution sampled from the superposition.

### (Supplementary Note 22)

The program according to any one of Supplementary Notes 17 to 21, wherein

the models are deductive models generated theoretically or inductive models generated based on data.

### (Supplementary Note 23)

The program according to any one of Supplementary Notes 17 to 22, further causing a computer to operate as:

the posterior distribution weight determination means that determines the weights such that a sum total of the weights is equal to or smaller than one.

### (Supplementary Note 24)

The program according to any one of Supplementary Notes 17 to 23, further causing a computer to operate as:

acquisition means for acquiring a simulation condition that is a condition at the simulation, an initial state of the state vector, and the observation data; and

output means for outputting time-series of the state vector.

As above, although the present invention has been described with reference to the example embodiments, the present invention is not limited to the above example embodiments. Various modifications that can be understood by a person skilled in the art can be made to configurations and details of the present invention within the scope of the present invention.

This application claims priority based on Japanese Patent Application No. 2015-111855 filed on Jun. 2, 2015, the disclosure of which is incorporated herein in its entirety.

### REFERENCE SIGNS LIST

10 Data input unit
11 Simulation condition storage unit
12 Observation data storage unit
13 Initial setting unit
14 Acquisition unit
20 Model ensemble unit
21 System model
21-1 First system model
21-2 Second system model
21-m mth system model
22 Prior distribution storage unit
22-1 First prior distribution storage unit
22-2 Second prior distribution storage unit
22-m mth prior distribution storage unit
30 Ensemble update unit
31 Posterior distribution generation unit
31-1 First posterior distribution generation unit
31-2 Second posterior distribution generation unit
31-m mth posterior distribution generation unit
32 Posterior distribution storage unit
32-1 First posterior distribution storage unit
32-2 Second posterior distribution storage unit
32-m mth posterior distribution storage unit
33 Posterior distribution weight determination unit
34 Input distribution storage unit
35 Model likelihood storage unit
40 Data output unit
41 Time series state vector storage unit
42 Output unit
100 Simulation device
200 Simulation device
201 Crop growth model
201-1 First crop growth model
201-m mth crop growth model
210 Data input unit
211 Input data storage unit
300 Simulation device
1000 Computer
1001 Processor
1002 Memory
1003 Storage device
1004 I/O interface
1005 Storage medium

What is claimed is:

1. A simulation device comprising:
a memory that stores a set of instructions; and
at least one first processor configured to execute the set of instructions to:
calculate, based on a state vector as an input, time evolutions of the state vector by simulation according to models, for at least two different models;
generate, based on the time evolutions of the state vector and observation data, posterior distributions of the time evolutions of the state vector and model likelihoods that are likelihoods, based on the observation data, of the models; and
determine, based on the posterior distributions and the model likelihoods, weights of the posterior distributions, and calculate, based on the weights and the posterior distributions, a next state vector of the state vector.

2. The simulation device according to claim 1, wherein
the at least one first processor is further configured to:
calculate model likelihoods sequentially based on observation data obtained before the posterior distributions are generated or based on newly obtained observation data.

3. The simulation device according to claim 1, wherein
the at least one first processor is further configured to:
determine the weights such that the weights are proportional to the model likelihoods.

4. The simulation device according to claim 1, wherein
the at least one first processor is further configured to:
calculate, based on input distributions, probability distributions as time evolutions of the state vector, the input distributions being probability distributions that approximate the state vector as an input; and
calculate, based on the posterior distributions and the weights, the input distributions as the next state vector.

5. The simulation device according to claim 4, wherein
the at least one first processor is further configured to:
update the posterior distributions by using the weights, generate a superposition of the updated posterior distributions, and generate the input distribution as a distribution sampled from the superposition.

6. The simulation device according to claim 1, wherein
the models are deductive models generated theoretically or inductive models generated based on data.

7. The simulation device according to claim 1, wherein
the at least one first processor is further configured to:
determine the weights such that a sum total of the weights is equal to or smaller than one.

8. The simulation device according to claim 1, comprising:
the at least one first processor is further configured to:
acquire a simulation condition that is a condition at the simulation, an initial state of the state vector, and the observation data; and
output time-series of the state vector.

9. A simulation method comprising:
calculating, based on a state vector as an input, time evolutions of the state vector by simulation according to models, for at least two different models;
generating, based on the time evolutions of the state vector and observation data, posterior distributions of the time evolutions of the state vector and model likelihoods that are likelihoods, based on the observation data, of the models; and
determining, based on the posterior distribution and the model likelihood, weights of the posterior distributions, and calculating, based on the weights and the posterior distributions, a next state vector of the state vector.

10. A non-transitory computer readable storage medium storing a program that causes a computer to operate as:
model ensemble processing of calculating, based on a state vector as an input, time evolutions of the state vector by simulation according to models, for at least two different models;
posterior distribution generation processing of generating, based on the time evolutions of the state vector and observation data, posterior distributions of the time evolutions of the state vector and model likelihoods that are likelihoods, based on the observation data, of the models; and
posterior distribution weight determination processing of determining, based on the posterior distributions and the model likelihoods, weights of the posterior distributions, and calculating, based on the weights and the posterior distributions, a next state vector of the state vector.
